(19) United States
(12) Patent Application Publication
(10) Pub. No.: US 2002/0192533 A1
(43) Pub. Date: Dec. 19, 2002

(54) Membrane electrode assembly for a fuel cell and a method for producing the same

(76) Inventors: Ulrich Gebhardt, Langensendelbach (DE); Arno Mattejat, Bubenreuth (DE); Igor Mehltretter, Buckenhof (DE); Manfred Waidhas, Nurnberg (DE)

Correspondence Address: LERNER AND GREENBERG, P.A., Post Office Box 2480, Hollywood, FL, 33022-2480, US

(21) Appl. No.: 10/178,414

(22) Filed: Jun. 24, 2002

Related U.S. Application Data
(63) Continuation of application No. PCT/DE00/04595, filed on Dec. 22, 2000.

(30) Foreign Application Priority Data
Dec. 23, 1999 (DE) 199 62 686.3

(51) Int. Cl. H01M 4/86; H01M 8/10; B05D 5/12

(52) U.S. Cl. 429/40; 429/30; 427/115

(57) ABSTRACT

A membrane electrode assembly for a fuel cell, in particular a PEM fuel cell, has an asymmetric distribution of the expensive precious metal on the membrane. The asymmetric distribution is realized in accordance with the requirements of the particular region. In the production, the electrodes are coated with membrane first of all, rather than the other way round.

### CROSS-REFERENCE TO RELATED APPLICATION

This application is a continuation of copending International Application No. PCT/DE00/04595, filed Dec. 22, 2000, which designated the United States and was not published in English.

### BACKGROUND OF THE INVENTION

Field of the Invention

The invention relates to a membrane electrode assembly for a fuel cell, in particular a PEM fuel cell, and to a method for producing the same.

A membrane electrode assembly (MEA) wherein catalytically active electrode coatings are applied directly to the membrane is shown in the older German patent application DE 198 50 119 (not a prior art reference). A general property of electrodes produced in that and similar ways is that they are coated to a homogeneous thickness with a uniform concentration of active material. Since the reaction of the process gases takes place the so-called 3-phase boundary layer (catalyst, gas, electrolyte), a large part of the catalyst is unused for the electrochemical reaction in each electrode.

The prior art has disclosed gas diffusion electrodes with catalyst layers wherein different catalyst materials and/or concentrations of precious metal are distributed over the surface of the electrode. For example, Japanese patent applications JP 03-245463 A and JP 09-035723 A describe electrodes for use in fuel cells, wherein different catalytic activities can be set at the entry and exit for the process gases. A corresponding result is also to be found in European patent applications EP 0 654 837 A and EP 0 736 921 A. Finally, U.S. Pat. No. 5,607,785 discloses a method for producing a PEM fuel cell wherein catalytic material is applied in clusters, the distribution and/or size of which can be predetermined differently. Measures of this type are in each case described separately on their own.

As fuel cell technology is being implemented in practice, in particular for mobile applications in fuel cells, minimizing costs plays an important role, and consequently there is a demand for the thickness of the coating to be made flexible and therefore optimized for each region of the membrane.

### SUMMARY OF THE INVENTION

It is accordingly an object of the invention to provide a membrane electrode assembly for a fuel cell and a fabrication method, which overcomes the above-mentioned disadvantages of the heretofore-known devices and methods of this general type and which ensures flexibility in the thickness of the electrocatalyst layer.

With the foregoing and other objects in view there is provided, in accordance with the invention, a membrane electrode assembly for a fuel cell. The assembly comprises:

a membrane;

an electrode containing precious metal, adjoining the membrane, and forming an electrocatalyst layer at a boundary region with the membrane;

wherein a catalytic property is defined by a concentration of the electrocatalyst layer and/or a precious metal concentration, and the catalytic property is asymmetrical to take account of a fuel cell operation with the process gas; and

the catalytic property in the entry region is different from the catalytic property in the exit region; and

the catalytic property decreases with one of a thickness of the electrocatalyst layer and a distance from the membrane.

In other words, the invention relates to a membrane electrode assembly for a fuel cell, wherein the electrocatalyst layer and/or the precious metal concentration is asymmetrical, the distribution of the electrocatalyst layer and/or of the precious metal concentration being matched to the requirements of the particular region of the membrane. The invention also relates to a method for producing a membrane electrode assembly wherein the membrane is rolled and/or sprayed onto the electrode.

It has emerged that on the active cell surface area where the reaction of the process gases takes place, the partial pressure of reactants in the process gas and/or the temperature is not identical throughout. The reaction rate and therefore the number of gas particles which come into contact with precious metal on the catalyst surface per unit time, where they are activated for reaction at the interface with the membrane, rises or falls as a function of the partial pressure and/or temperature of the process gases.

A low concentration of catalyst powder and/or precious metal is required in those regions of the active cell surface at which high process gas with a high proportion of reactant and a high temperature prevail (e.g. at the gas inlet). However, a higher degree of occupancy of the membrane with catalyst powder and/or precious metal is expedient at regions of the active cell surface where the flow of process gas is lower, in order as far as possible to achieve a uniform reaction over the entire surface.

In accordance with an added feature of the invention, the following relationship applies:

C_{E}≠C_{M}≠C_{A},

where C_{E} represents the catalytic property at the entry region of the process gas, C_{M} represents the catalytic property in a central region of the assembly, and C_{A} represents the catalytic property at the exit region of the process gas.

In accordance with an additional feature of the invention, the concentration of the electrocatalyst layer in the entry region of the process gas is lower than the concentration of the electrocatalyst layer in the exit region of the process gas.

In accordance with another feature of the invention, the precious metal concentration in the entry region of the process gas is lower than the precious metal concentration in the exit region of the process gas.

In accordance with a further feature of the invention, the electrocatalyst layer is applied directly to the membrane.

With the above and other objects in view there is also provided, in accordance with the invention, a method of producing a membrane electrode assembly (as outline above), which comprises:

providing an electrode for a fuel cell;

applying a membrane to the electrode by rolling the membrane onto the electrode and/or spraying the membrane onto the electrode.

Preferably, the membrane coating is applied on both sides of the electrode.

In accordance with a concomitant feature of the invention, in each case one half of the membrane electrode assembly is produced, and the membrane is rolled or sprayed with two separate halves onto a respective electrode.

In accordance with a further feature of the invention, the electrocatalyst layer has a fixed support.

According, therefore, to one embodiment of the membrane electrode assembly, an asymmetric, solid support for the catalyst powder, such as a metal nonwoven and/or a carbon fabric, which promotes an asymmetric distribution of the catalyst layer and/or the precious metal is present on the membrane.

The asymmetry of the layer of catalyst powder and/or precious metal occupancy and/or of the support relates to the thickness and/or height of the layer and/or of the support and/or to the concentration of the precious metal in the layer, so that a layer of uniform thickness but different concentrations of precious metal is-also covered by the term “asymmetrical” used in the present document.

According to one preferred embodiment of the membrane electrode assembly, the electrode does not have a fixed support, but rather the membrane is asymmetrically coated with catalyst paste or catalyst ink according to the reaction rate of the region. The coating may be effected by rolling or spraying.

According to the embodiment which has just been described, the electrode also directly adjoins the membrane, without a fixed support, in which case the asymmetry of the precious metal concentration in the electrode was introduced during production of the catalyst paste and/or catalyst ink.

Other features which are considered as characteristic for the invention are set forth in the appended claims.

Although the invention is illustrated and described herein as embodied in a membrane electrode assembly for a fuel cell and a method for producing the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a section through the upper half of a membrane electrode assembly with the coating of an electrocatalyst powder; and

FIG. 2 shows a plan view of a membrane electrode assembly.

### DESCRIPTION OF THE PREFERRED EMBODIMENTS

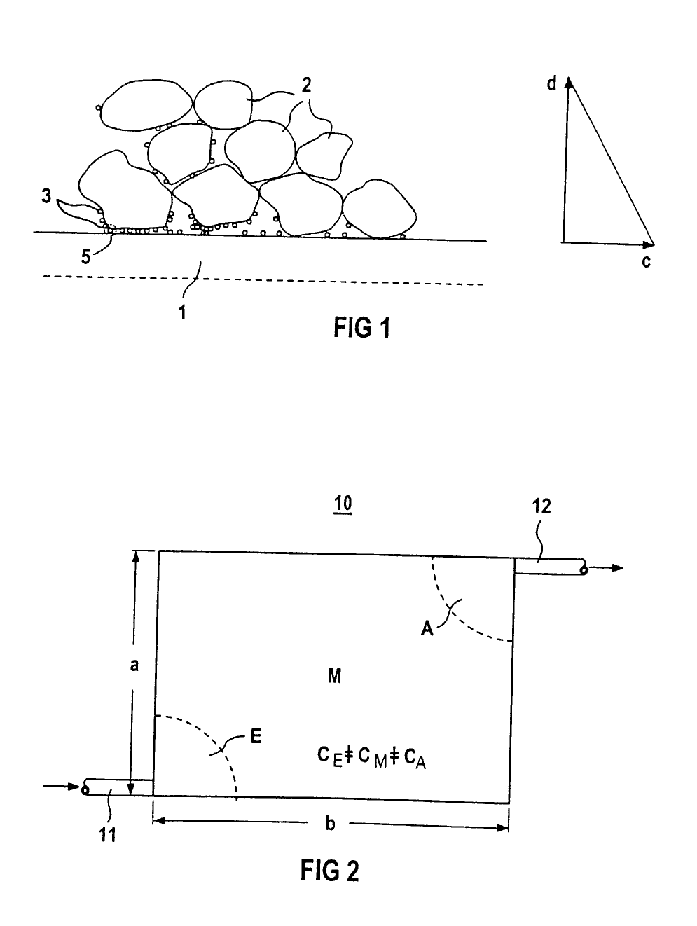

Referring now to the figures of the drawing in detail and first, particularly, to FIG. 1 thereof, there is shown a polymer membrane 1, which forms the core component of a membrane electrode assembly (MEA) of a PEM (polymer electrode membrane, proton exchange membrane) fuel cell. Membranes of this type are commercially available under the trade name Nafion. Only the upper part is illustrated in FIG. 1.

To define an electrode, for example a cathode of the MEA, catalyst powder, on the one hand, and carbon particles as support for the catalyst particles, on the other hand, are applied to the membrane. The-specific result is a thin film-of catalyst directly on the surface of the membrane. It is possible to reduce the concentration of the catalyst according to demand as a function of the distance from the membrane surface. FIG. 1 indicates individual soot particles 2, on the surfaces of which the considerably finer catalyst particles 3 have accumulated. The surface of the membrane 1 and regions of the carbon or soot grains 2 and catalyst particles 3 in each case form regions with a three-phase boundary, as indicated by 5.

It may be expedient for a substantially continuous, thin film of catalyst particles to be provided on the membrane 1, so that in this case a high concentration of catalyst results. At a distance from the membrane surface, only individual catalyst particles have accumulated at the carbon grains, without any further catalyst material being present toward the outer surface of the electrode, at which an electrode support may be present. Therefore, there is a gradient in the catalyst concentration, since on the outside there is no longer any need for any catalyst powder, which consists of expensive precious metal. In this way, it is possible to achieve considerable cost savings for practical use.

In FIG. 2, an MEA is denoted by the reference numeral 10. The plan view of the electrode surface shows a rectangular area with dimensions a and b. There is an inlet 11 for process gas and an outlet 12 for process gas. In the area, there are three separate regions, specifically a region E in the vicinity of the inlet, a region M in the center and a region A in the vicinity of the outlet.

Practical experience gained in connection with concentrations of reactant in the process gas and catalyst occupancy have shown that in the inlet region E of the electrode surface there is a lower demand for catalyst than in the outlet region A, where there is a lower level of reactant which is to be reacted in the process gas.

Just as shown in FIG. 1, the asymmetry is produced in the direction of distance from the membrane, but can also be achieved by having a high precious metal concentration in certain regions of the surface of the membrane and only a low precious metal concentration in other regions of the membrane electrode assembly. In general, the following relationship applies to a concentration C of catalyst along the electrode surface:

C_{E}≠C_{M}≠C_{A} (1)

Where in particular:

C_{E}<C_{A}. (2)

The measures of adapting the concentration also result in considerable savings. Irrespective of this, the electrochemical reaction is made more even over the surface area.

A further exemplary embodiment of an asymmetric occupancy of catalyst is expedient when additional catalyst materials are being used. For example, if uncleaned reformer gases are being used, the high level of CO, which is known to be catalyst poison in the case of platinum, the CO can be deliberately reacted in the inlet region by the use of a catalyst, such as for example ruthenium, which has a high catalytic activity for CO oxidation. Then, pure platinum is available in the outlet region for reaction of the reaction gas.

An asymmetric structure of the catalyst layer is also advantageous for optimized thermal management, in particular for selective autothermal heating of the cell or stack by direct recombination of the reactants in the cell. A similar but external heating method is described in a different context.

The term (electro)catalyst powder, paste, ink and/or general electrocatalyst layer is used to denote the catalytically active coating, depending on the production stage, which allows the controlled hydrogen-oxygen reaction in the fuel cell unit. The finished electrocatalyst layer on the membrane is referred to as an electrode and contains precious metal in a concentration which is sufficient for process gas particles which come into contact with the layer to be activated. A typical example of a catalyst powder is platinum powder.

The term membrane denotes any type of membrane and/or matrix which forms a polymer electrolyte within the fuel cell.

In the method for producing the membrane electrode assembly which has been described, according to one embodiment a membrane rests on the hot roller which is used to coat an electrode. According to another embodiment of the method, the membrane is sprayed onto the electrode. The thickness of the membrane is approximately half that of the finished membrane. The two electrodes are separately coated with membrane, so that in each case one half of the membrane electrode assembly is formed. The membrane electrode assembly is then formed by applying the two membrane halves to one another.

According to the latter procedure, the finished membrane electrode assembly is only formed by final assembly of the fuel cell stack, since only then, as a result of the two coated electrodes coming into contact with one another, do the membrane halves meet, so that the actual membrane electrolyte is formed in the required thickness. The working step wherein the membrane halves are combined can advantageously be used to allow further layers, such as a further catalyst layer, electrolyte powder or other materials to be incorporated in the center of the membrane.

The invention produces an asymmetric distribution of the expensive catalyst powder and/or precious metal on the membrane, according to the requirements of the particular region of the membrane. The production method is distinguished by the fact that for the first time the electrodes are coated with membrane rather than, as in the prior art, the electrode coating being applied to the membrane.

We claim:

1. A membrane electrode assembly for a fuel cell operated with process gas and having an entry region and an exit region of the process gas, comprising:
a membrane;
an electrode containing precious metal, adjoining said membrane, and forming an electrocatalyst layer adjoining said membrane;
wherein a catalytic property is defined by at least one of a concentration of said electrocatalyst layer and a precious metal concentration, and the catalytic property is asymmetrical to take account of a fuel cell operation with the process gas; and
said catalytic property in the entry region is different from the catalytic property in the exit region; and
the catalytic property decreases with one of a thickness of said electrocatalyst layer and a distance from said membrane.

2. The membrane electrode assembly according to claim 1, wherein the following relationship applies:
C_{E}≠C_{M}≠C_{A},
where C_{E} represents the catalytic property at the entry region of the process gas, C_{M} represents the catalytic property in a central region of the assembly, and C_{A} represents the catalytic property at the exit region of the process gas.

3. The membrane electrode assembly according to claim 2, wherein the concentration of said electrocatalyst layer in the entry region of the process gas is lower than the concentration of the electrocatalyst layer in the exit region of the process gas.

4. The membrane electrode assembly according to claim 2, wherein the precious metal concentration in the entry region of the process gas is lower than the precious metal concentration in the exit region of the process gas.

5. The membrane electrode assembly according to claim 1, wherein said electrocatalyst layer has a fixed support.

6. The membrane electrode assembly according to claim 1, wherein said electrocatalyst layer is applied directly to said membrane.

7. A method of producing a membrane electrode assembly for a fuel cell, which comprises:
providing an electrode for a fuel cell;
applying a membrane to said electrode with a process selected from the group consisting of rolling the membrane onto the electrode and spraying the membrane onto the electrode.

8. The method according to claim 7, which comprises applying membrane coating on both sides of the electrode.

9. The method according to claim 7, which comprises in each case producing one half of the membrane electrode assembly, and rolling or spraying the membrane with two separate halves onto a respective electrode.
